(19) United States
(12) Patent Application Publication
(10) Pub. No.: US 2010/0124184 A1
(43) Pub. Date: May 20, 2010

(54) METHODS AND SYSTEMS WITH FRAME STRUCTURE FOR IMPROVED ADJACENT CHANNEL CO-EXISTENCE

(75) Inventors: Pranav Dayal, San Diego, CA (US); Miguel Griot, Huntington Beach, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/426,280

(22) Filed: Apr. 20, 2009

Related U.S. Application Data
(60) Provisional application No. 61/114,668, filed on Nov. 14, 2008.

(51) Int. Cl. H04L 5/14; H04W 4/00

(52) U.S. Cl. 370/280; 370/328

(57) ABSTRACT

Methods and systems are provided for supporting co-existence of two radio access technologies (RATs), which include determining the frame structure of a first RAT, including the boundary of subframes, the DL:UL subframe ratio, and switching periodicity, selecting a frame offset and a DL:UL subframe ratio in a second RAT to minimize the number of punctured symbols in the second RAT, and transmitting frames in the second RAT with the selected frame offset and subframe ratio.

### CLAIM OF PRIORITY

This application claims the benefit of priority from U.S. Provisional Patent Application Ser. No. 61/114,668, entitled “Frame Structure for Improved Adjacent Channel Co-Existence” and filed Nov. 14, 2008, which is assigned to the assignee of this application and is fully incorporated herein by reference for all purposes.

### TECHNICAL FIELD

Certain embodiments of the present disclosure generally relate to wireless communication and, more particularly, to defining a frame structure for a network supported by a first radio access technology (RAT) to co-exist with a second network supported by a second RAT.

### SUMMARY

Certain embodiments of the present disclosure provide a method for supporting co-existence of first and second radio access technologies (RATs) in adjacent channels. The method generally includes determining a frame structure of the first RAT, comprising a boundary of subframes, a downlink to uplink (DL:UL) subframe ratio, and a switching periodicity, selecting a frame offset and a DL:UL subframe ratio in the second RAT based, at least on a corresponding resulting number of punctured symbols in the second RAT given the switching periodicity, and transmitting frames in the second RAT with the selected frame offset and subframe ratio.

Certain embodiments of the present disclosure provide an apparatus for supporting co-existence of first and second radio access technologies (RATs) in adjacent channels. The apparatus generally includes logic for determining a frame structure of the first RAT, comprising a boundary of subframes, a downlink to uplink (DL:UL) subframe ratio, and a switching periodicity, logic for selecting a frame offset and a DL:UL subframe ratio in the second RAT based, at least on a corresponding resulting number of punctured symbols in the second RAT given the switching periodicity, and logic for transmitting frames in the second RAT with the selected frame offset and subframe ratio.

Certain embodiments of the present disclosure provide an apparatus for supporting co-existence of first and second radio access technologies (RATs) in adjacent channels. The apparatus generally includes means for determining a frame structure of the first RAT, comprising a boundary of subframes, a downlink to uplink (DL:UL) subframe ratio, and a switching periodicity, means for selecting a frame offset and a DL:UL subframe ratio in the second RAT based, at least on a corresponding resulting number of punctured symbols in the second RAT given the switching periodicity, and means for transmitting frames in the second RAT with the selected frame offset and subframe ratio.

Certain embodiments of the present disclosure provide a computer-program product for supporting co-existence of first and second radio access technologies (RATs) in adjacent channels, comprising a computer readable medium having instructions stored thereon, the instructions being executable by one or more processors. The instructions generally include instructions for determining a frame structure of the first RAT, comprising a boundary of subframes, a downlink to uplink (DL:UL) subframe ratio, and a switching periodicity, instructions for selecting a frame offset and a DL:UL subframe ratio in the second RAT based, at least on a corresponding resulting number of punctured symbols in the second RAT given the switching periodicity, and instructions for transmitting frames in the second RAT with the selected frame offset and subframe ratio.

### BRIEF DESCRIPTION OF THE DRAWINGS

So that the manner in which the features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system that utilizes orthogonal frequency-division multiplexing/multiple access (OFDM/OFDMA) technology in accordance with certain embodiments of the present disclosure.

FIG. 4 illustrates two examples of frame alignment between a frame in a Long Term Evolution-Time Division Duplex (LTE-TDD) network and a frame in an Institute of Electrical and Electronics Engineers (IEEE) 802.16m network to support co-existence of the two networks, according to the existing IEEE 802.16m standard.

FIG. 5 illustrates an example of LTE-TDD frame structure.

FIG. 6 illustrates an example list of Downlink/Uplink (DL/UL) configurations in a frame in LTE-TDD standard.

FIG. 7 illustrates example operations required to configure a system utilizing a radio access technology (RAT) to co-exist with a system utilizing a different RAT in adjacent channels, in accordance with certain embodiments of the present disclosure.

FIG. 7A is a block diagram of means corresponding to the example operations of FIG. 7.

FIG. 8 illustrates an example of frame offset and DL:UL subframe ratio calculated for a frame in an IEEE 802.16m network to coexist in adjacent channels with a frame utilizing the zeroth frame configuration of LTE-TDD standard, in accordance with certain embodiments of the present disclosure.

FIG. 9 illustrates an example of frame offset and DL:UL subframe ratio, in accordance with certain embodiments of the present disclosure.

FIG. 10 illustrates an example of frame offset and DL:UL subframe ratio calculated for a frame in an IEEE 802.16m network to coexist in adjacent channels with a frame utilizing the second frame configuration of LTE-TDD standard, in accordance with certain embodiments of the present disclosure.

### DETAILED DESCRIPTION

Certain embodiments are described herein with reference to the drawings, wherein like reference numerals are used to refer to like elements throughout. In the following description, for purposes of explanation, numerous specific details are set forth in order to provide a thorough understanding of certain embodiments. However, it may be that such embodiment(s) can be practiced without these specific details. In other instances, well-known structures and devices are shown in block diagram form in order to facilitate describing certain embodiments.

A network supported by a first radio access technology (RAT), such as Institute of Electrical and Electronics Engineers (IEEE) 802.16m, may be deployed in the same or in an overlapping geographical area with other wireless networks supporting other RATs. In IEEE 802.16m System Description Document (SDD), adjacent channel co-existence with Evolved UMTS (Universal Mobile Telecommunications System) Terrestrial Radio Access (E-UTRA) standard in Time Division Duplex (TDD) mode is supported. E-UTRA is the air interface for the Long Term Evolution (LTE) upgrade path for mobile networks. LTE is a project within the third Generation Partnership Project (3GPP) to improve UMTS mobile phone standard to cope with future technology evolutions.

Adjacent channel co-existence with other RATs may be facilitated by inserting either idle symbols or idle subframes into an IEEE 802.16m frame, and configuring a frame offset. In addition, IEEE 802.16m standard supports symbol puncturing to minimize inter-system interference.

IEEE 802.16m SDD does not specify details, such as TDD partition or frame offset of a frame in IEEE 802.16m network, for adjacent channel coexistence with a frame in a LTE-TDD network. If a TDD partition or a frame offset is not chosen properly, many symbols in an IEEE 802.16m frame may have to be punctured, which reduces the efficiency of the system.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16 is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

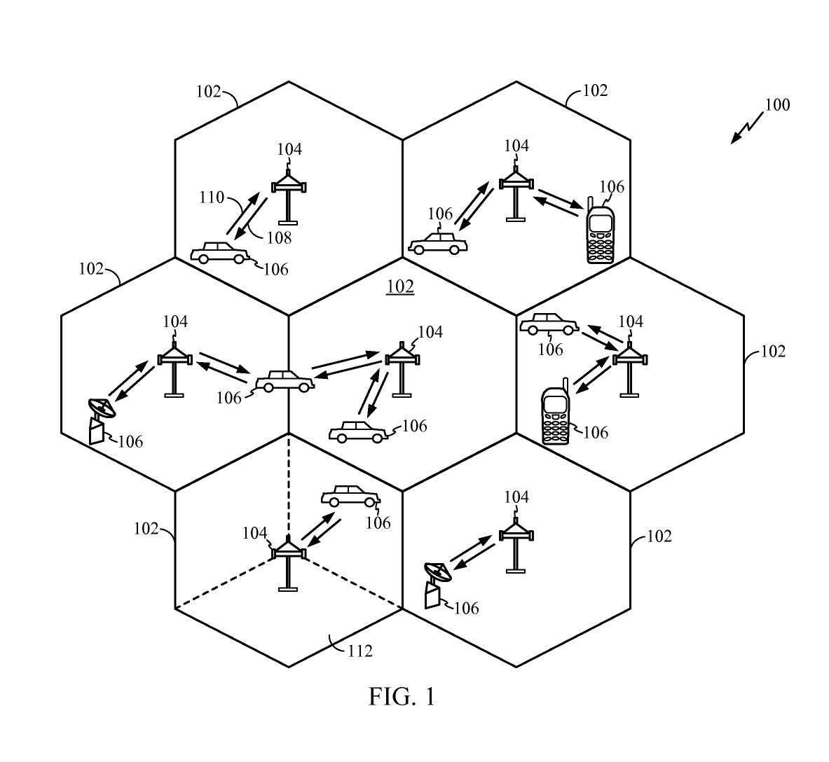

FIG. 1 illustrates an example of a wireless communication system 100 in which embodiments of the present disclosure may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. User terminals 106 may be fixed (i.e., stationary) or mobile. User terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

Cell 102 may be divided into multiple sectors 112. Sector 112 is a physical coverage area within a cell 102. Base stations 104 within a wireless communication system 100 may utilize antennas that concentrate the flow of power within a particular sector 112 of the cell 102. Such antennas may be referred to as directional antennas.

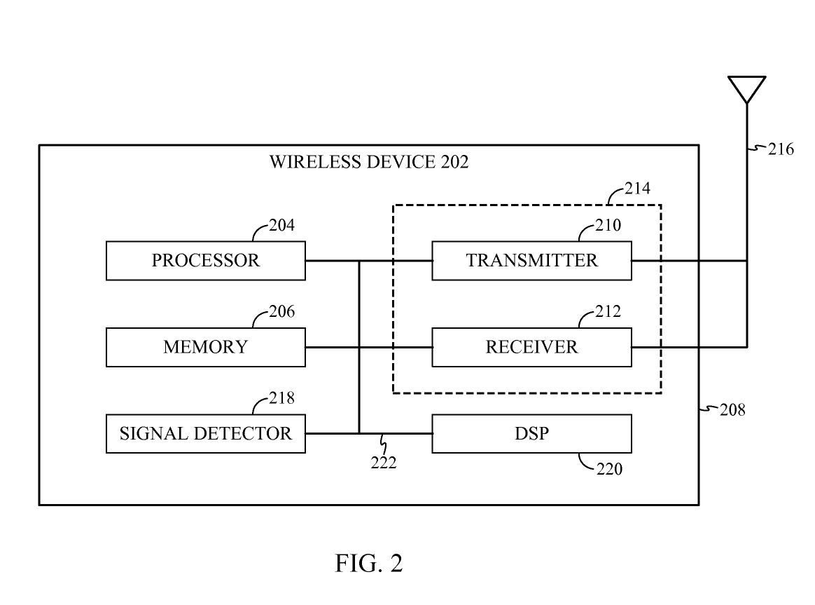

FIG. 2 illustrates various components that may be utilized in a wireless device 202 that may be employed within the wireless communication system 100. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to processor 204. A portion of memory 206 may also include non-volatile random access memory (NVRAM). Processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy per pseudonoise (PN) chips, power spectral density and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

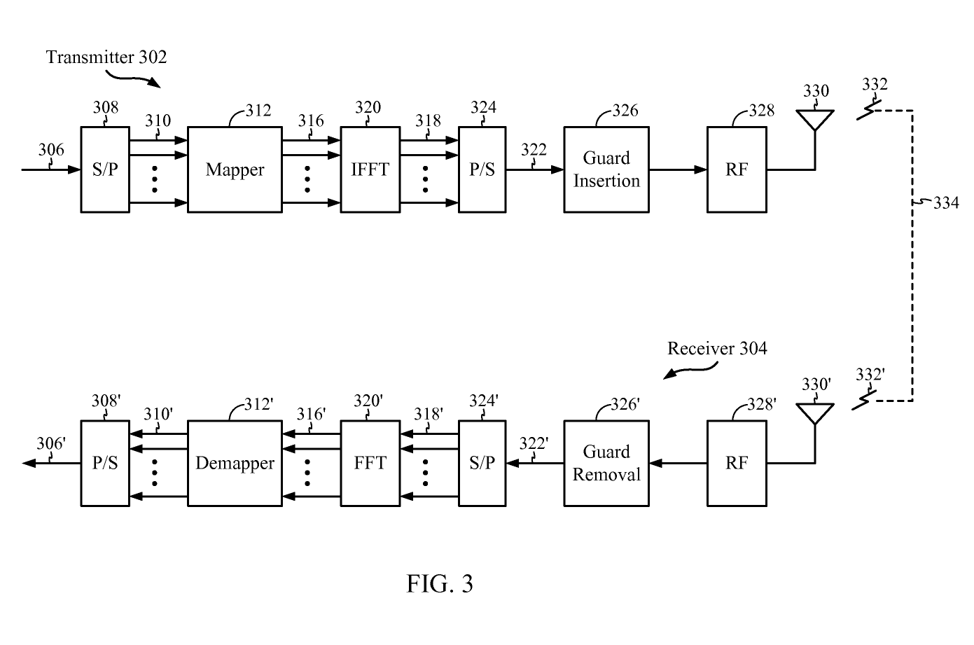

FIG. 3 illustrates an example of a transmitter 302 that may be used within a wireless communication system 100 that utilizes OFDM/OFDMA. Portions of transmitter 302 may be implemented in transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Ns, is equal to Ncp (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless device 202 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312 thereby outputting N parallel data streams 310′. A P/S converter 308′ may combine the N parallel data streams 310′ into a single data stream 306′. Ideally, this data stream 306′ corresponds to the data 306 that was provided as input to the transmitter 302. Note that elements 308′, 310′, 312′, 316′, 320′, 318′ and 324′ may all be found on a in a baseband processor.

### Exemplary Frame Structure for Improved Adjacent Channel Co-Existence

A network supported by a radio access technology (RAT), such as IEEE 802.16m may be deployed in the same or in an overlapping geographical area with other wireless networks supporting other RATs. Depending on the frequency band in which an IEEE 802.16m network is expected to be deployed, different coexistence scenarios may be possible. For example, in IEEE 802.16m system description document(SDD), adjacent channel co-existence with E-UTRA (CDMA TDD) and UTRA low chip rate (LCR) networks in TDD mode are supported.

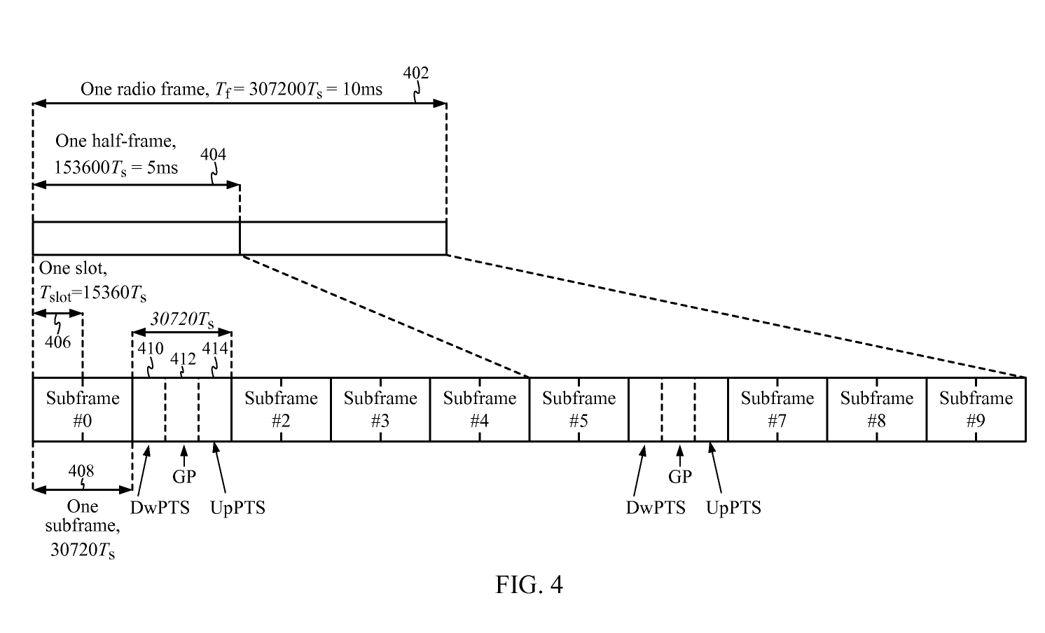

FIG. 4 illustrates an example structure of a frame in TDD mode in LTE-TDD standard. As illustrated, each 10 ms radio frame 402 is divided into two 5 ms half frames 404. Each half frame consists of 10 subframes 408. An LTE-TDD frame includes a special frame (S) containing three parts: downlink pilot time slot (DwPTS) 410, guard period (GP) 412 and uplink pilot time slot (UpPTS) 414. The guard period (GP) counters the propagation delay of the inter-site distance so as to avoid base station to base station interference when switching between downlink and uplink transmissions. The fields DwPTS, GP and UpPTS may span, for example, 3˜12, 1˜10 and 1˜2 OFDM symbols, respectively.

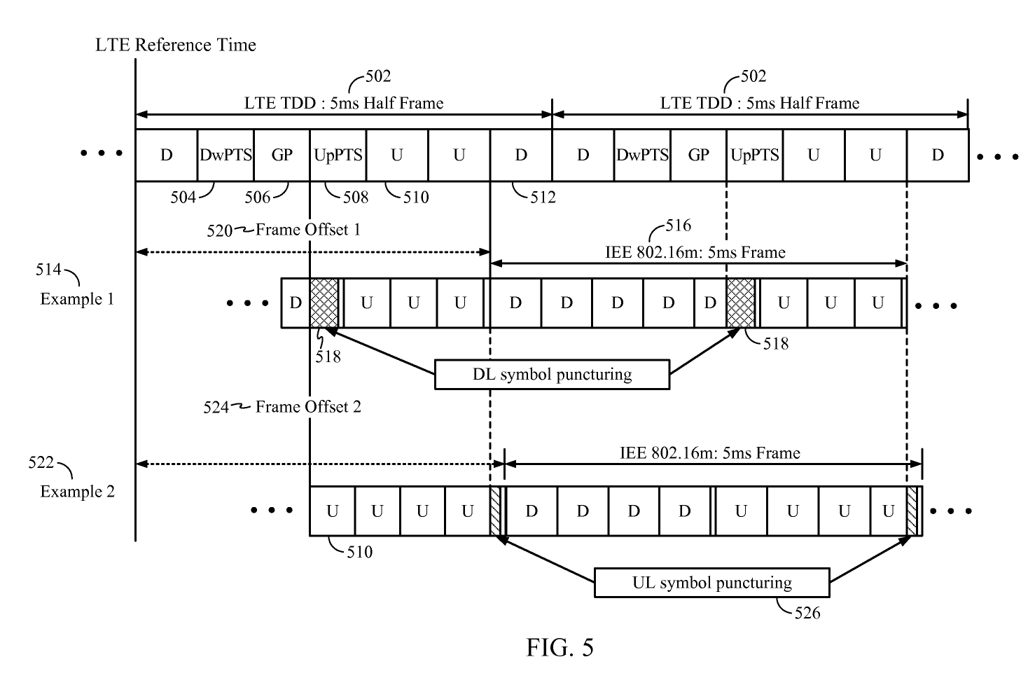

FIG. 5 illustrates two examples of adjacent channel coexistence between LTE-TDD and IEEE 802.16m networks provided in the IEEE 802.16m SDD. An LTE-TDD frame can be divided to two half frames 502. Each frame contains downlink 512 and uplink 510 subframes and DwPTS 504, GP 506 and UpPTS 508 fields. An IEEE 802.16m frame 516 may coexist with the LTE-TDD frame in two different example scenarios. In the first example scenario 514, an IEEE 802.16m TDD frame may be aligned with starting point of consecutive downlink (DL) sub-frames 512 in a LTE-TDD frame. In the second example scenario 522, an IEEE 802.16m uplink (UL) frame may be aligned with the starting point of the uplink pilot time slot (UpPTS) 508 field in the LTE-TDD frame.

A frame offset 520, 524 is the delay of the beginning of an IEEE 802.16m frame with respect to the beginning of a LTE-TDD frame. Since sub-frame sizes and DL/UL configuration periods are different in IEEE 802.16m and LTE-TDD systems, some DL and UL symbols may be punctured 518, 526 to align the DL and UL regions in the two frames. Puncturing, or deleting some of the symbols, reduces inter-system interference between the IEEE 802.16m and LTE-TDD systems by preventing simultaneous DL and UL transmissions in two adjacent channels. Number of punctured symbols in an IEEE 802.16m frame should be minimized to maintain spectral efficiency of an IEEE 802.16m system.

As illustrated in FIG. 5, adjacent channel co-existence with other RATs may be facilitated by inserting either idle symbols or subframes into an IEEE 802.16m frame, and configuring a frame offset. In addition, IEEE 802.16m standard supports symbol puncturing to minimize inter-system interference.

IEEE 802.16m SDD does not specify details, such as TDD partition or frame offset of a frame in IEEE 802.16m network for adjacent channel coexistence with a frame in a LTE-TDD network. If a TDD partition or a frame offset is not chosen properly, many symbols in an IEEE 802.16m frame may have to be punctured, which reduces efficiency of the system.

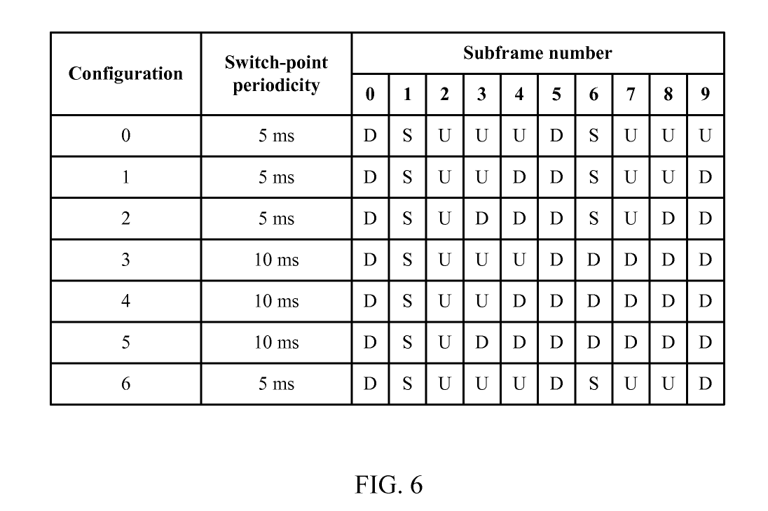

FIG. 6 illustrates an example list of the downlink/uplink configurations in a LTE-TDD frame according to the LTE standard. In this table D, U and S indicate Downlink, Uplink and Special subframes, respectively. The special subframe S may consist of DwPTS, GP, and UpPTS fields. As illustrated, several DL/UL configurations for 5 ms switch point periodicity and 10 ms switch point periodicity may be chosen for an LTE-TDD frame. The configurations 0, 1 and 2 have two identical 5 ms half-frames within a 10 ms LTE-TDD frame.

According to certain embodiments of the present disclosure, an optimal offset value to minimize the number of punctured symbols may be chosen for the best alignment between an IEEE 802.16m frame and a LTE-TDD frame for each of the configurations 0 to 6 of a LTE-TDD frame. The ratio between the number of downlink and uplink subframes (DL:UL) for an IEEE 802.16m frame should be chosen with respect to the DL:UL ratio of the LTE-TDD frame to minimize the overhead of punctured symbols in the IEEE 802.16m frame.

For certain embodiments of the present disclosure, for the LTE-TDD configurations with 5 ms switch-point periodicity, switching point of an IEEE 802.16m frame may coincide with a guard period (GP) in the LTE network. Thus, a UL in the IEEE 802.16m frame may begin at the same time or after the UpPTS field in the LTE-TDD network.

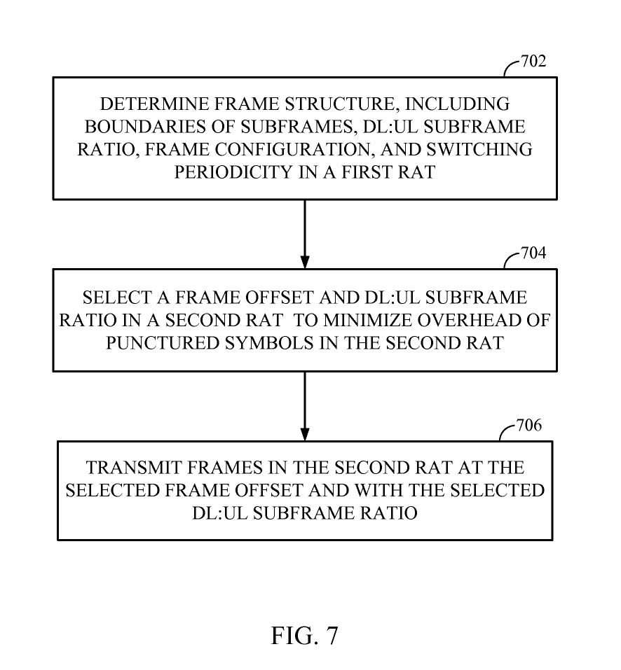

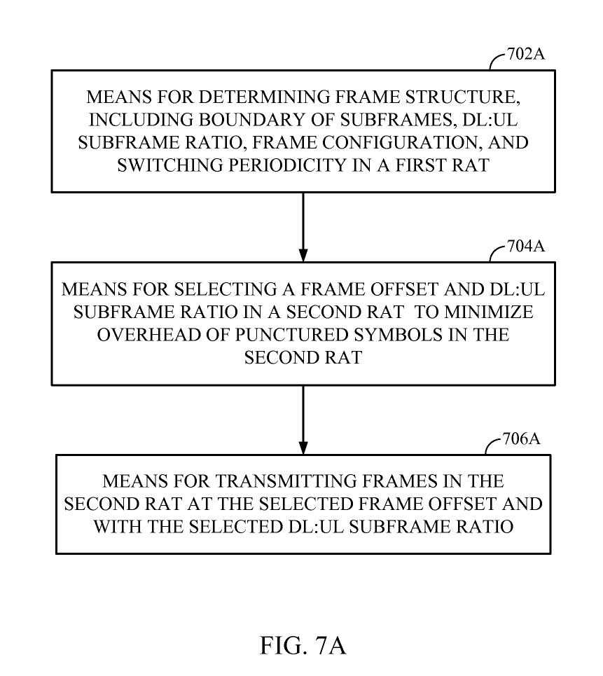

FIG. 7 illustrates example operations required to configure a network utilizing a radio access technology (RAT) to coexist with a network utilizing a different RAT in adjacent channels, in accordance with certain embodiments of the present disclosure. For certain embodiments, the first RAT may be an LTE-TDD network. Also, for some embodiments, the second RAT may be an IEEE 802.16m network.

As illustrated in FIG. 7, frame structure of the first RAT is determined, at 702. For example, the boundaries of subframes, the DL:UL subframe ratio, frame configuration and switching periodicity are determined in the first RAT. At 704, a frame offset and a DL:UL subframe ratio are selected for the second RAT. The frame offset and the DL:UL subframe ratio are selected to minimize the number of punctured symbols in the second RAT. Once the frame structure is selected in the second RAT, the second RAT transmits frames using the selected frame structure, shown at 706. The above operations ensure co-existence of the two RATs in adjacent channels with minimal overhead.

For certain embodiments, IEEE 802.16m OFDMA symbol length may be 102.8 μs and LTE-TDD symbol length may be 71 μs. Therefore, a mismatch in the boundaries of the subframes in LTE-TDD and IEEE 802.16m frames may exist. To minimize the interference between two adjacent networks, simultaneous uplink and downlink transmissions should be avoided in two adjacent channels, in which simultaneous uplink and downlink transmissions refer to simultaneous uplink transmission in one RAT and downlink transmission in another RAT. Puncturing of the OFDM symbols in the IEEE 802.16m frame ensures that no simultaneous downlink and uplink transmission occurs in two adjacent channels. In order to minimize the number of punctured symbols, the optimum DL:UL ratio of IEEE 802.16m frame must be chosen with respect to each of the LTE TDD frame configurations.

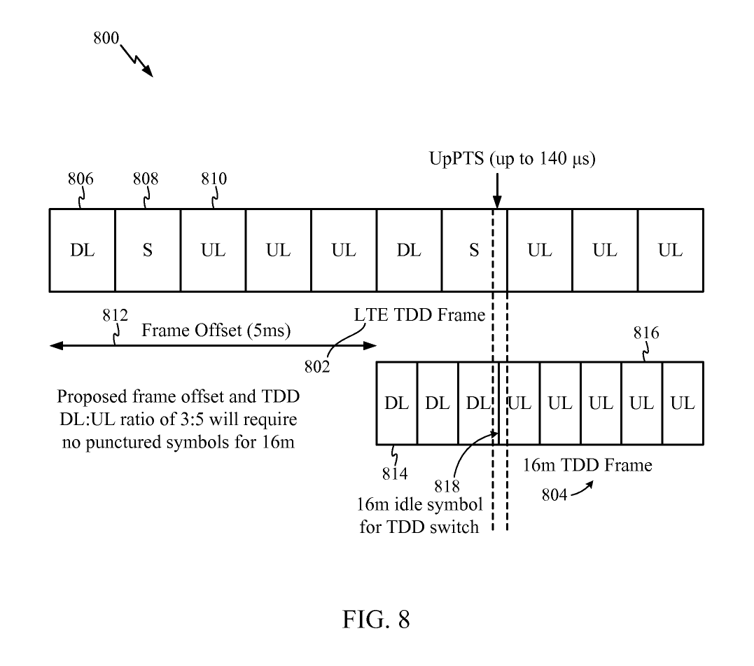

FIG. 8 illustrates an example frame offset and a DL:UL subframe ratio for an IEEE 802.16m frame to coexist in adjacent channels with a frame utilizing the zeroth configuration of LTE-TDD frame, in accordance with certain embodiments of the present disclosure. As illustrated in FIG. 8, an LTE-TDD frame 802 with the zeroth frame configuration consists of DL 806, S 808 and UL 810 subframes with certain locations for each of the subframes according to the table in FIG. 6. For certain embodiments, a frame offset 812 equal to 5 ms and a DL:UL subframe ratio of 3:5 may be utilized for an IEEE 802.16m frame 804 to coexist with the zeroth configuration of the LTE-TDD frame with minimum overhead. With the 3:5 frame structure, none of the symbols in the IEEE 802.16m frame are punctured. There may only be one idle symbol 818 in the IEEE 802.16m frame to facilitate TDD switch between downlink 814 and uplink 816 subframes. As used herein, the term ‘idle symbol’ generally refers to a symbol that is already set not to be transmitted by 802.16m, irrespective of coexistence issues with other RATs (i.e., this symbol would be punctured for 802.16m transmission). As used herein, the term ‘punctured symbol’ generally refers to a symbol that is punctured for coexistence of the two RATs.

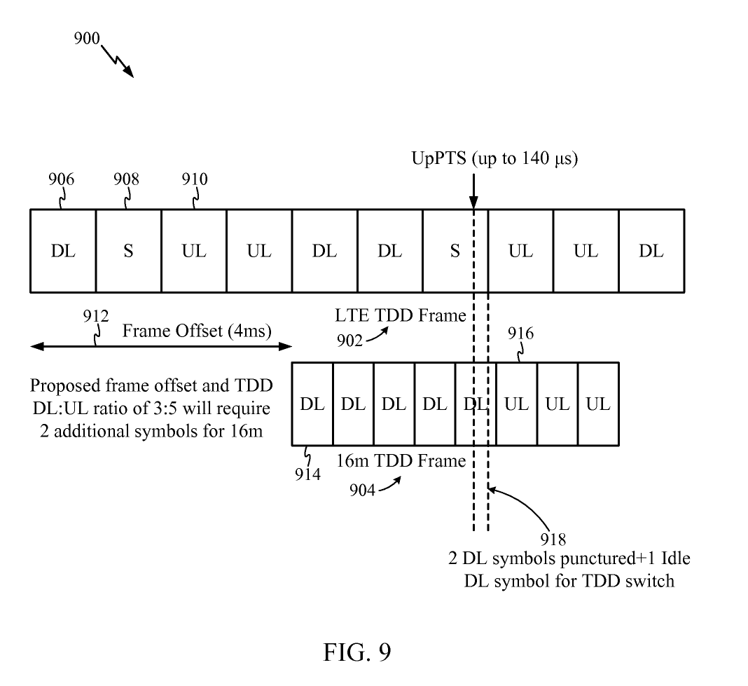

FIG. 9 illustrates an example frame offset and a DL:UL subframe ratio for an IEEE 802.16m frame to coexist in adjacent channels with a frame utilizing the first configuration of the LTE-TDD frame, in accordance with certain embodiments of the present disclosure. As illustrated in FIG. 9, an LTE-TDD frame 902 with the first frame configuration consists of DL 906, S 908 and UL 910 subframes with certain locations for each of the subframes according to the table in FIG. 6. For certain embodiments, a frame offset 912 equal to 4 ms and a DL:UL subframe ratio of 5:3 may be used for an IEEE 802.16m frame 904 to coexist with the first configuration of the LTE-TDD frame with minimum overhead. With the 5:3 frame structure, at 918, two DL symbols in the IEEE 802.16m frame may be punctured and one idle DL symbol may be inserted to facilitate the TDD switch between the downlink 914 and uplink 916 subframes. Utilizing other DL:UL ratios may result in higher overhead. For example, utilizing a DL:UL ratio of 4:4 may require four punctured UL symbols in the IEEE 802.16m frame to co-exist with a frame using the first configuration of LTE-TDD.

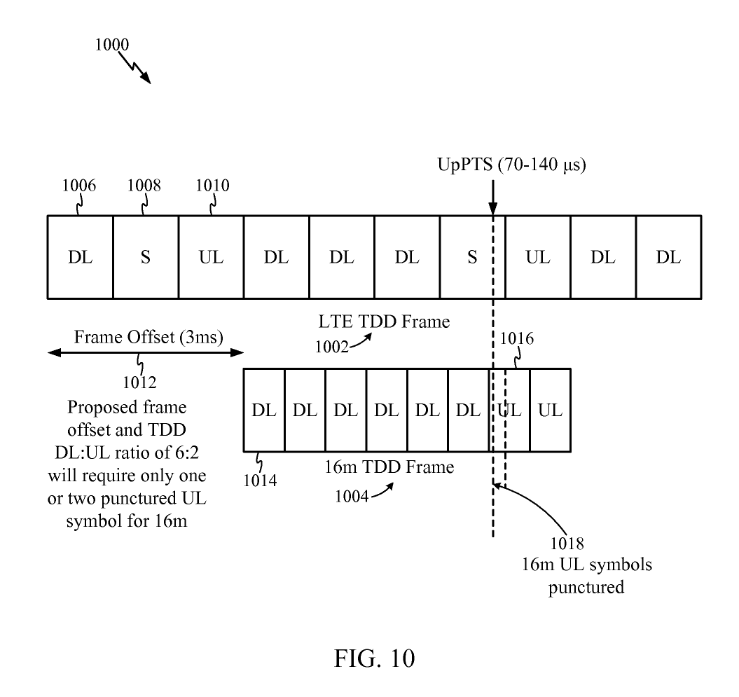

FIG. 10 illustrates an example frame offset and a DL:UL subframe ratio for an IEEE 802.16m frame to coexist with a frame utilizing the second configuration of the LTE-TDD frame, in accordance with certain embodiments of the present disclosure. As illustrated in FIG. 10, an LTE-TDD frame 1002 with the second frame configuration consists of DL 1006, S 1008 and UL 1010 subframes with certain locations for each of the subframes according to the table in FIG. 6. For certain embodiments, a frame offset 1012 equal to 3 ms and a DL:UL subframe ratio of 6:2 may be used for an IEEE 802.16m frame 1004 to coexist with the second configuration of the LTE-TDD frame with minimum overhead. With the 6:2 frame structure, at 1018, there may only be one or two punctured symbols in the IEEE 802.16m frame in order to align the downlink 1014 and uplink 1016 subframes with the downlink and uplink subframes in the LTE-TDD frame. The determination of how many symbols to puncture (e.g. one or two) may be made based on the length of UpPTS field in the LTE frame.

As illustrated above, certain embodiments of the present disclosure provide frame offset and DL:UL subframe ratios for frames in the IEEE 802.16m standard to coexist in adjacent channels with the LTE-TDD frames in the zeroth, first and second configurations with 5 ms switching periodicity. A similar idea can be used for the configurations with 10 ms switching periodicity of the LTE frame, such as in the LTE-TDD Configurations 3-6 indicated in FIG. 6. For some embodiments, a suitable IEEE 802.16m frame structure of length 5 ms can be chosen for each half-frame of length 5 ms in the LTE frame structure.

It may be noted that, since some LTE TDD configurations discussed above have different patterns in each half of the radio frame (e.g., a 5 ms frame), the IEEE 802.16m frame structures used may be different in consecutive 5 ms frames to minimize the puncturing. As an alternative, or in addition, a fixed TDD ratio for the IEEE 802.16m may be chosen to minimize the sum of the total punctured symbols for the two 5 ms durations.

The various operations of methods described above may be performed by various hardware and/or software component(s) and/or module(s) corresponding to means-plus-function blocks illustrated in the Figures. For example, blocks 702-706 illustrated in FIG. 7 correspond to means-plus-function blocks 702A-706A illustrated in FIG. 7A. More generally, where there are methods illustrated in Figures having corresponding counterpart means-plus-function Figures, the operation blocks correspond to the means-plus-function blocks with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for supporting co-existence of first and second radio access technologies (RATs) in adjacent channels, comprising:
determining a frame structure of the first RAT, comprising a boundary of subframes, a downlink to uplink (DL:UL) subframe ratio, and a switching periodicity;
selecting a frame offset and a DL:UL subframe ratio in the second RAT based, at least in part, on a corresponding resulting number of punctured symbols in the second RAT given the switching periodicity; and
transmitting frames in the second RAT with the selected frame offset and subframe ratio.

2. The method of claim 1, wherein the frame offset and DL:UL subframe ratio in the second RAT are selected to minimize the number of punctured symbols in the second RAT.

3. The method of claim 2, wherein the second RAT comprises Institute of Electrical and Electronics Engineers (IEEE) 802.16m.

4. The method of claim 1, wherein the first RAT comprises Evolved UMTS (Universal Mobile Telecommunications System) Terrestrial Radio Access (E-UTRA) or Long Term Evolution-Time Division Duplex (LTE-TDD).

5. The method of claim 1, further comprising determining a different frame structure of the first RAT for subsequent transmissions.

6. An apparatus for supporting co-existence of first and second radio access technologies (RATs) in adjacent channels, comprising:
logic for determining a frame structure of the first RAT, comprising a boundary of subframes, a downlink to uplink (DL:UL) subframe ratio, and a switching periodicity;
logic for selecting a frame offset and a DL:UL subframe ratio in the second RAT based, at least in part, on a corresponding resulting number of punctured symbols in the second RAT given the switching periodicity; and
logic for transmitting frames in the second RAT with the selected frame offset and subframe ratio.

7. The apparatus of claim 6, wherein the frame offset and DL:UL subframe ratio in the second RAT are selected to minimize the number of punctured symbols in the second RAT.

8. The apparatus of claim 7, wherein the second RAT comprises Institute of Electrical and Electronics Engineers (IEEE) 802.16m.

9. The apparatus of claim 6, wherein the first RAT comprises Evolved UMTS (Universal Mobile Telecommunications System) Terrestrial Radio Access (E-UTRA) or Long Term Evolution-Time Division Duplex (LTE-TDD).

10. The apparatus of claim 6, wherein the logic for determining a frame structure determines a different frame structure of the first RAT for subsequent transmissions.

11. An apparatus for supporting co-existence of first and second radio access technologies (RATs) in adjacent channels, comprising:
means for determining a frame structure of the first RAT, comprising a boundary of subframes, a downlink to uplink (DL:UL) subframe ratio, and a switching periodicity;
means for selecting a frame offset and a DL:UL subframe ratio in the second RAT based, at least in part, on a corresponding resulting number of punctured symbols in the second RAT given the switching periodicity; and
means for transmitting frames in the second RAT with the selected frame offset and subframe ratio.

12. The apparatus of claim 11, wherein the frame offset and DL:UL subframe ratio in the second RAT are selected to minimize the number of punctured symbols in the second RAT.

13. The apparatus of claim 12, wherein the second RAT comprises Institute of Electrical and Electronics Engineers (IEEE) 802.16m.

14. The apparatus of claim 11, wherein the first RAT comprises Evolved UMTS (Universal Mobile Telecommunications System) Terrestrial Radio Access (E-UTRA) or Long Term Evolution-Time Division Duplex (LTE-TDD).

15. The apparatus of claim 11, wherein the means for determining a frame structure determines a different frame structure of the first RAT for subsequent transmissions.

16. A computer-program product for supporting co-existence of first and second radio access technologies (RATs) in adjacent channels, comprising a computer readable medium having instructions stored thereon, the instructions being executable by one or more processors and the instructions comprising:
instructions for determining a frame structure of the first RAT, comprising a boundary of subframes, a downlink to uplink (DL:UL) subframe ratio, and a switching periodicity;
instructions for selecting a frame offset and a DL:UL subframe ratio in the second RAT based, at least in part, on a corresponding resulting number of punctured symbols in the second RAT given the switching periodicity; and
instructions for transmitting frames in the second RAT with the selected frame offset and subframe ratio.

17. The computer-program product of claim 16, wherein the frame offset and DL:UL subframe ratio in the second RAT are selected to minimize the number of punctured symbols in the second RAT.

18. The computer-program product of claim 17, wherein the second RAT comprises Institute of Electrical and Electronics Engineers (IEEE) 802.16m.

19. The computer-program product of claim 16, wherein the first RAT comprises Evolved UMTS (Universal Mobile Telecommunications System) Terrestrial Radio Access (E-UTRA) or Long Term Evolution-Time Division Duplex (LTE-TDD).

20. The computer-program product of claim 16, wherein the instructions further comprise instructions for determining a different frame structure of the first RAT for subsequent transmissions.
